(19) United States
(12) Patent Application Publication
(10) Pub. No.: US 2007/0200877 A1
(43) Pub. Date: Aug. 30, 2007

(54) Method for producing nozzle substrate, method for producing droplet-discharging head, head for discharging droplets, and apparatus for discharging droplets

(75) Inventor: Katsuji Arakawa, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/703,753

(22) Filed: Feb. 7, 2007

(30) Foreign Application Priority Data
Feb. 27, 2006 (JP) 2006049577
Oct. 16, 2006 (JP) 2006281305

(51) Int. Cl. B41J 2/01; G01D 15/00

(52) U.S. Cl. 347/1; 216/27

(57) ABSTRACT

The present invention includes a step of forming concave portions to be nozzle openings by an etching process on a substrate to be processed, a step of bonding a first support substrate to a surface of the concave-portion-formed process side, a step of subjecting the processed substrate to a thinning process from a surface of an opposite side of a surface bonded to the first support substrate so as to have a desired thickness, thereby opening an end of the concave portion, a step of bonding a second support substrate to a surface of the concave-portion-opened side, a step of separating the first support substrate from the processed substrate and bonding a third support substrate to the separated surface of the processed substrate, and a step of separating the second support substrate from the processed substrate.

The entire disclosure of Japanese Patent Application Nos. 2006-49577 filed on Feb. 27, 2006 and 2006-281305 filed on Oct. 16, 2006 is expressly incorporated by reference herein.

### BACKGROUND OF THE INVENTION

1. Field of the Invention

The present invention relates to a method for producing a nozzle substrate having nozzle openings for discharging droplets, a method for producing a droplet-discharging head, a head for discharging droplets, and an apparatus for discharging droplets.

2. Description of the Related Art

As a droplet-discharging head for discharging droplets, for example, an inkjet head to be loaded in an inkjet recording apparatus is known. Such an inkjet head generally comprises, a nozzle substrate on which a plurality of nozzle openings for discharging inkdrops are formed, and a cavity substrate, which is bonded to the nozzle substrate and on which an ink flow pathway having a discharge chamber in communication with the nozzle openings of the nozzle substrate and a reservoir and so forth are formed, wherein a pressure is applied to the discharge chamber by a driving part and thereby the inkdrops are discharged from the nozzle openings selected. As means of driving, there are a system of utilizing an electrostatic force, a piezoelectric system using an piezoelectric element, a system of utilizing a heat-emitting element, and so on.

In recent years, for such inkjet heads, a requirement for higher quality of printing and image quality and so forth has increased, and therefore higher density and improvement of discharge performance has been strongly required. Under such circumstances, for a nozzle part of the inkjet head, various artifices and proposals has been made.

In the inkjet head, in order to improve an ink discharge characteristic, it is desirable to control resistance in a flow pathway in the nozzle part, and to control the thickness of the substrate so that the nozzle has the most appropriate length. In the case of producing such a nozzle substrate, for example, as shown in Japanese Unexamined Patent Application Publication No. 11-28820 (Pages 4 and 5, and FIGS. 3 and 4), there has been adopted a method of, subjecting a silicon substrate to anisotropic dry etching using ICP (Inductively Coupled Plasma) electric discharge from one surface thereof, thereby forming the first nozzle opening (a jet orifice portion of each of the nozzle openings) and the second nozzle opening (a feed port portion of each of the nozzle openings) that have two stages in order to constitute the nozzle part, then tunneling down into one part of the nozzle from an opposite surface thereof by anisotropic wet etching, and thereby controlling the length of the nozzle.

On the other hand, as shown in Japanese Unexamined Patent Application Publication No. 09-57981 (Pages 2 and 3, and FIGS. 1 and 2), there is a method of, preliminarily polishing a silicon substrate to have a desired thickness, subjecting both sides of the silicon substrate to a dry etching, and thereby forming the jet orifice portion of each of the nozzle openings and the feed port portion thereof.

### SUMMARY

However, there has been a problem in that when a discharge surface on which each of the nozzle openings is opened is a bottom face of a concave portion having a height significantly lower than the substrate surface as shown in Japanese Unexamined Patent Application Publication No. 11-28820 (Pages 4 and 5, and FIGS. 3 and 4), flight deviation of the inkdrops is caused, or in the case in which a paper powder, an ink, or the like causing clogging of the nozzle openings adheres to the concave portion bottom face that is the discharge surface, it becomes difficult to perform a wiping operation for wiping the concave portion bottom face with a rubber piece, a felt piece, or the like in order to remove such a paper powder and an ink.

Moreover, in the production method of Japanese Unexamined Patent Application Publication No. 09-57981 (Pages 2 and 3, and FIGS. 1 and 2), there has been a problem in that as the inkjet head has higher density, the thickness of the silicon substrate has to be further thinner, and however, the silicon substrate subjected to such a thinning process is easy to break in the production process and becomes expensive. Furthermore, in the dry etching process, the etching has occasionally become impossible because cooling down is performed with a He gas or the like from the back surface of the substrate so as to stabilize the processed shape, and therefore the He gas leaks when the nozzle openings are passed through. Therefore, there has been adopted a method of, preliminarily forming concave portions to be nozzle openings on the silicon substrate, bonding the silicon substrate to a support substrate such as a quartz glass by using a resin, then subjecting the silicon substrate to a thinning process such as grinding or etching process, and thereby opening the nozzle openings (the concave portions).

However, in the bonding through an adhesive resin, break or crack has occasionally generated on the silicon substrate subjected to the thinning process because the resin having low viscosity gets into the concave portions to be the nozzle openings and therefore it is not easy to peel off the resin layer when the resin layer is segregated form the silicon substrate. Moreover, yield has been lowered by generation of clogging of the resin in the concave portions to be the nozzle openings, or productivity has been lowered because a step for removing the resin clogged in the nozzle is required.

Moreover, the yield has occasionally lowered because of the following reason. Since the resin has got into the concave portions to be the nozzle openings, a crack is generated from a peripheral part of the silicon substrate so as to reach the head part when removing the support substrate or the resin layer.

The present invention has been accomplished to solve such problems as described above. It is an object thereof to provide a method for producing a nozzle substrate, in which when a substrate to be processed such as a silicon substrate is subjected to a thinning process, the substrate is not damaged with being firmly attached to and held by a support substrate, in which after the processing, the support substrate can be easily separated from the processed substrate, and in which even if a crack is generated on the substrate to be processed, the crack is made not to reach a head part and thereby handling is easy, so as to be useful for improvement of yield or productivity. It is also an object to provide a method for producing a droplet-discharging head, a head for discharging droplets, and an apparatus for discharging droplets, using the nozzle substrate.

To achieve the above object, a method for producing a nozzle substrate according to the present invention, comprises:

a step of forming, by an etching process, a plurality of concave portions to be nozzle openings for discharging droplets, on a substrate to be processed;

a step of bonding a first support substrate to a surface of a process side of the processed substrate on which the concave portions are formed;

a step of subjecting the processed substrate to a thinning process from a surface opposite to a surface bonded to the first support substrate, so that the substrate has a desired thickness thereby opening an end of each of the concave portions;

a step of bonding a second support substrate to a surface of the opened side on which the end of each of the concave portions is opened;

a step of separating the first support substrate from the processed substrate and bonding a third support substrate to the separated surface of the processed substrate; and

a step of separating the second support substrate from the processed substrate.

According to the method for producing a nozzle substrate, it is possible to optimize a length of each of the nozzle openings by subjecting the processed substrate to a thinning process to make the substrate have a desired thickness, in the state that the processed substrate is bonded to a first support substrate. Moreover, even after the processed substrate is separated from the first support substrate, the processed substrate is held by the second support substrate. Therefore, neither a break nor a chip is generated even when the processed substrate is thinned (made to be a thin plate). Handling is easy, and yield and productivity can be improved.

The method for producing a nozzle substrate according to the present invention, comprising:

a step of forming, by an etching process, a plurality of concave portions to be nozzle openings for discharging droplets and a peripheral groove, on a substrate to be processed;

a step of bonding a first support substrate to a surface of a process side of the processed substrate on which the concave portions and the peripheral groove are formed;

a step of subjecting the processed substrate to a thinning process from a surface opposite to a surface bonded to the first support substrate, so that the processed substrate has a desired thickness, thereby opening an end of each of the concave portions and the peripheral groove;

a step of bonding a second support substrate to a surface of the opened side on which the end of each of the concave portions and the peripheral groove is opened;

a step of separating the first support substrate from the processed substrate and bonding a third support substrate to the separated surface of the processed substrate; and

a step of separating the second support substrate from the processed substrate.

According to the method for producing a nozzle substrate, because a peripheral groove is formed on the processed substrate as well as the nozzle openings, and furthermore the second support substrate is being adhered to the processed substrate. Therefore the first support substrate is separated, even if a crack is generated from the peripheral part of the processed substrate during removing the first support substrate, progress of the crack can be blocked at a part of the peripheral groove. Therefore, the crack can be certainly prevented from getting into a head chip portion. Accordingly, there is an effect that yield and productivity of the nozzle substrate is significantly improved.

In the present invention, preferably, the peripheral groove is formed in a peripheral part of the processed substrate so as to surround the entirety of a head-forming region in which a plurality of head chips are formed. Thereby, all of the head chips can be covered by one peripheral groove.

Moreover, it is possible that the peripheral groove includes a chip outside groove formed along a periphery of each of the individual head chips. In the case of providing the chip outside groove, it becomes possible to perform segregation by a chip without using dicing.

It is preferable that the peripheral groove is formed outside an alignment opening formed in the processed substrate. Thereby, a crack does not reach an alignment opening for positioning, and precision of alignment can be ensured.

Preferably, each of the first and the second support substrates is bonded to the processed substrate through a double-sided adhesive sheet. Thereby, a foreign matter such as adhesive resin does not enter inside of each of the nozzle openings, and therefore, improvement of yield and improvement of productivity can be accomplished at the same time.

Preferably, the double-sided adhesive sheet has a self-separation layer whose adhesive force is lowered by applying ultraviolet light or heat to an adhesive surface thereof. Thereby, in the thinning process of the processed substrate, the processed substrate can be firmly attached to each of the first and the second support substrates and thereby can be processed with no damage. And, after the processing, each of the first and the second support substrates can be easily separated from the processed substrate.

Moreover, the double-sided adhesive sheet has the self-separation layer on one surface thereof, and the processed substrate is attached to a side of the adhesive surface having the self-separation layer. Thereby, in the thinning process of the processed substrate, the processed substrate can be attached to a surface of a side having the self-separation layer and thereby can be processed with no damage. And, after the processing, each of the first and the second support substrates can be easily delaminated from the surface having the self-separation layer.

Also, it is possible that the double-sided adhesive sheet has the self-separation layer on both surfaces thereof, and the processed substrate and each of the first and the second support substrates are attached to the adhesive surfaces having the self-separation layers.

In the thinning process of the processed substrate, the substrate can be attached to each surface of the both sides having the self-separation layer and thereby can be processed with no damage. And, after the processing, each of the processed substrate and the first and the second support substrates can be easily delaminated from each surface of the both sides having the self-separation layers.

The processed substrate and each of the first and the second support substrates are bonded through the double-sided adhesive sheet under a reduced pressure environment.

By bonding the processed substrate and each of the first and the second support substrates through the double-sided adhesive sheet under a reduced pressure environment, air bubbles are not left on the adhesive interface, and therefore, uniform adhesion becomes possible. Therefore, variation of plate thicknesses of the processed substrate in the thinning process thereof is not caused.

Moreover, the processed substrate and each of the first and the second support substrates may be bonded through a resin layer in vacuum.

In this case, a resin for adhesion can be completely filled inside the nozzle openings. Moreover, this resin is advantageous for controlling the length of each of the nozzle openings because the resin functions as a stop layer for etching.

Moreover, the resin layer adheres to the processed substrate, and adheres to each of the first and the second support substrates through a separation layer made of a material allowing segregation of the separation layer by irradiation of light.

Because the separation layer is segregated from the resin layer with being subjected to irradiation of light, it becomes easy to separate the first and the second support substrate from the processed substrate.

When the first support substrate is separated from the processed substrate, in the case in which an adhesive resin is left in each of the nozzle openings, the remaining adhesive resin is removed by performing a plasma treatment.

Thereby, the adhesive resin is not left inside each of the nozzle openings, and therefore, troubles such as no discharge or the flight deviation can be solved.

In the present invention, a shape of each of the nozzle openings are not particularly limited. However, by forming the nozzle opening to have two stages of a jet orifice portion for discharging droplets and a feed port portion having a concentric shape with that of the jet orifice portion and a diameter larger than that of the jet orifice portion, the discharge direction of droplets can be perpendicular to the substrate surface, and therefore, discharge performance can be improved.

In this case, it is desirable that each of the nozzle openings is formed by anisotropic dry etching with ICP electric discharge.

According to the anisotropic dry etching with ICP electric discharge, highly precise openings can be opened perpendicularly to the substrate surface.

Moreover, it is desirable that the anisotropic dry etching is performed by using C₄F₈ and SF₆ as an etching gas.

Because C₄F₈ functions to protect the side surface of each of the nozzle openings so as to prevent etching from progressing in the direction of the side surface thereof and SF₆ functions to promote etching in the perpendicular direction, the nozzle openings can be high-precisely processed perpendicularly to the substrate surface.

A method for producing a droplet-discharging head according to the present invention is that in any one of the above-described methods for producing a nozzle substrate, the third support substrate, to which the processed substrate is bonded, is a silicon substrate in order to form a cavity substrate having a flow pathway in communication with the nozzle opening or a reservoir substrate in which a flow pathway in communication with the nozzle opening is previously formed.

Thereby, it is possible to produce a droplet-discharging head of which handling is easy and production cost is inexpensive.

A head for discharging droplets according to the present invention, is produced by a method comprising:

a step of forming, by an etching process, a plurality of concave portions to be nozzle openings for discharging droplets, on a substrate to be processed;

a step of bonding a first support substrate to a surface of a process side of the processed substrate on which the concave portions are formed;

a step of subjecting the processed substrate to a thinning process from a surface of an opposite side of a surface bonded to the first support substrate, so that the substrate has a desired thickness, thereby opening an end of each of the concave portions;

a step of bonding a second support substrate to a surface of the opened side on which the end of each of the concave portions is opened;

a step of separating the first support substrate from the processed substrate and bonding a third support substrate to the separated surface of the processed substrate; and

a step of separating the second support substrate from the processed substrate.

Thereby, it is possible to obtain a droplet-discharging head by which improvement of yield and improvement of productivity can be accomplished at the same time.

A head for discharging droplets according to the present invention, is produced by a comprising:

a step of forming, by an etching process, a plurality of concave portions to be nozzle openings for discharging droplets and a peripheral groove, on a substrate to be processed;

a step of bonding a first support substrate to a surface of a process side of the processed substrate processed on which the concave portions and the peripheral groove are formed;

a step of subjecting the processed substrate to a thinning process from a surface of an opposite side of a surface bonded to the first support substrate, so that the substrate has a desired thickness thereby opening an end of each of the concave portions and the peripheral groove;

a step of bonding a second support substrate to a surface of the opened side on which the end of each of the concave portions and the peripheral groove is opened;

a step of separating the first support substrate from the processed substrate and bonding a third support substrate to the separated surface of the processed substrate; and

a step of separating the second support substrate from the processed substrate.

Thereby, it is possible to obtain a droplet-discharging head by which improvement of yield and improvement of productivity can be accomplished at the same time.

An apparatus for discharging droplets according to the present invention comprises any one of the above-described heads for discharging droplets.

Thereby, it is possible to provide an droplet-discharging apparatus of which production cost is inexpensive.

### BRIEF DESCRIPTION OF THE DRAWINGS

FIG. 1 is an exploded perspective view showing a schematic constitution of an inkjet head according to an embodiment of the present invention;

FIG. 2 is a sectional view of the inkjet head showing a schematic constitution of the right half of FIG. 1 in an assembly state;

FIG. 3 is an upper surface view of the inkjet head of FIG. 2;

FIGS. 4A to 4E are sectional views of a nozzle substrate in production steps showing an example of the method for producing a nozzle substrate;

FIGS. 5F to 5J are sectional views in production steps following FIGS. 4A to 4E;

FIGS. 6K to 6O are sectional views in production steps following FIGS. 5F to 5J;

FIGS. 7P and 7Q are sectional views in production steps following FIGS. 6K to 6O;

FIGS. 8R and 8S are a back surface view of the nozzle substrate and an upper surface view of a first support substrate;

FIG. 9T is a side view of an alignment jig for positioning, showing the nozzle substrate and a cavity substrate in a step of bonding;

FIGS. 10U and 10V are section views showing a bonding state of the nozzle substrate and the cavity substrate and a separated state of a second support substrate;

FIG. 11 is a back surface view of the nozzle substrate on which a peripheral groove including a chip outside groove;

FIGS. 12A to 12D are sectional views showing steps of producing an electrode substrate;

FIGS. 13E to 13H are sectional views of the cavity substrate and the electrode substrate in production steps showing a method for producing;

FIG. 14 is a sectional view of an inkjet head showing another embodiment of the present invention;

FIGS. 15K to 15O are sectional views of a nozzle substrate in production steps showing another example of a method for producing nozzle substrate;

FIGS. 16P to 16S are sectional views in production steps following FIGS. 15K to 15O; and

FIG. 17 is a perspective view of an inkjet printer using the inkjet head according to one embodiment of the present invention.

### DESCRIPTION OF THE PREFERRED EMBODIMENTS

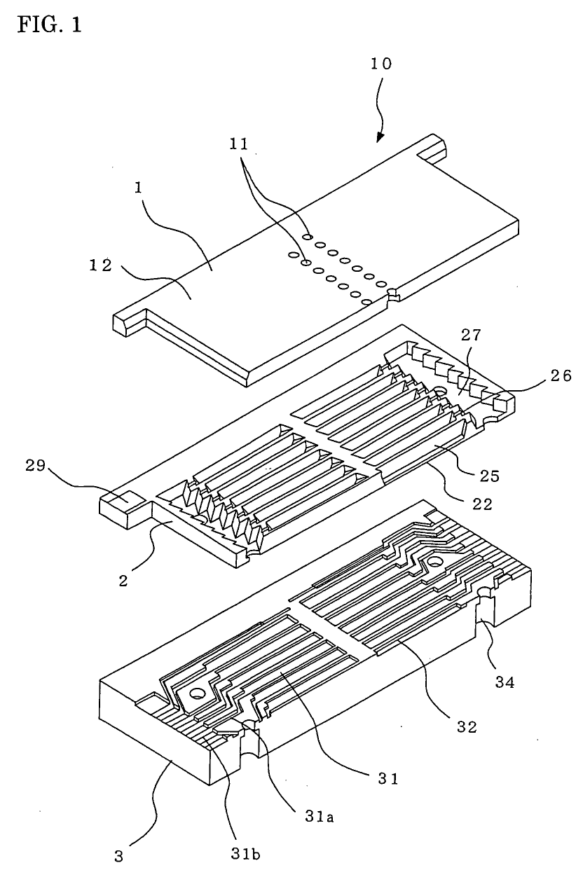

Hereinafter, embodiments of a droplet-discharging head having a nozzle substrate to which the present invention is applied will be explained with reference to drawings. Here, as an example of the droplet-discharging head, an electrostatic drive type inkjet head of a face discharge type, in which inkdrops are discharged from nozzle openings provided on a surface of the nozzle substrate, is explained with reference to FIGS. 1 to 3. In addition, the present invention is not limited to the structures or the forms shown in the following figures, and is similarly applicable to a droplet-discharging head of an edge discharge type in which droplets are discharged from nozzle openings provided at an edge of a substrate. Furthermore, the drive type is not limited to the electrostatic drive type, and is also applicable to a type of utilizing a piezoelectric element, a heat emitting element, or the like.

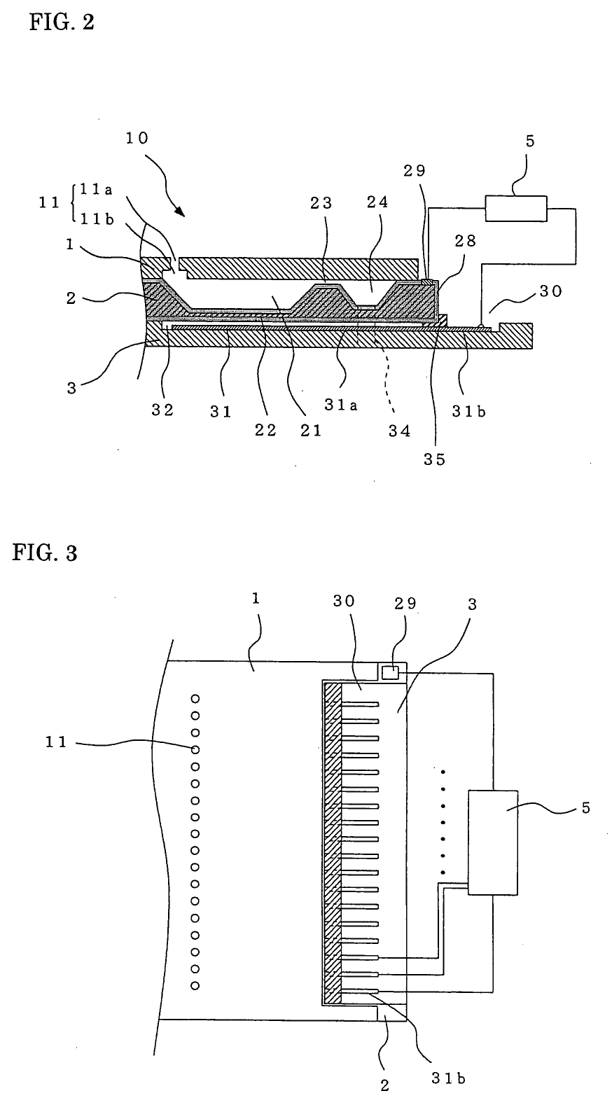

FIG. 1 is an exploded perspective view exploding and showing a schematic constitution of an inkjet head according to the present embodiment, and presents a part in a section. FIG. 2 is a section view of the inkjet head showing a schematic constitution of the right half of FIG. 1 in an assembly state. FIG. 3 is an upper surface view of the inkjet head of FIG. 2. In addition, in FIGS. 1 and 2, the inkjet head is shown upside down to a generally used state.

As shown in FIGS. 1 to 3, the inkjet head (an example of the droplet-discharging head) 10 of the present embodiment is formed by bonding a nozzle substrate 1, on which a plurality of nozzle openings 11 provided by a predetermined pitch, a cavity substrate 2, on which an ink supply pathway is individually provided for each of the nozzle openings 11, and an electrode substrate 3 provided with individual electrodes 31 disposed oppositely to diaphragms 22 of the cavity substrate 2.

Here, the cavity substrate 2 is to be a third support substrate to which a nozzle substrate 1 produced by an after-mentioned production method is bonded. Moreover, a reservoir substrate in which discharge chambers and a reservoir portion are formed on separate substrates can be the third support substrate.

Hereinafter, constitutions of the respective substrates will be explained in further detail.

The nozzle substrate 1 is produced from a silicon substrate thinned to have a required thickness (for example, a thickness of approximately 280 μm to 60 μm) by the later-described production method. In addition, a material of the nozzle substrate 1 is not limited to a silicon material.

The nozzle opening 11 for discharging inkdrops is formed of, for example, nozzle opening portions formed in a cylindrical shape of two stages having different diameters, namely, a jet orifice portion 11a having a small diameter and a feed port portion 11b having a larger diameter. The jet orifice portion 11a and the feed port portion 11b are provided perpendicularly to the substrate surface and on a same axis. The end of the jet orifice portion 11a is open on the front surface of the nozzle substrate 1, and the feed port portion 11b is open on the back surface (the surface of the bonded side to which the cavity substrate 2 is bonded). Moreover, on the discharge surface (the surface opposite to the bonded surface) of the nozzle substrate 1, an ink repellent film (not shown) is formed.

As described above, by forming the nozzle opening 11 to have two stages of a jet orifice portion 11a and a feed port portion 11b having a diameter larger than that of the jet orifice portion, discharge direction of inkdrops can be aligned in the central axis direction, and stable ink discharge characteristic can be exerted. That is, dispersion of flight directions of the inkdrops comes to disappear and the inkdrops do not scatter, so that dispersion of the discharge amount of the drops can be suppressed. Moreover, density of the nozzle can be higher.

The cavity substrate 2 is produced from, for example, a silicon substrate having a thickness of 525 μm. By subjecting this silicon substrate to a wet etching, a concave portion 25 to be a discharge chamber of an ink pathway, a concave portion 26 to be an orifice 23, and a concave portion 27 to be a reservoir 24, are formed. A plurality of the concave portions 25 are independently formed at positions corresponding to the nozzle openings 11. Therefore, when the nozzle substrate 1 and the cavity substrate 2 are bonded, each of the concave portion 25 forms a discharge chamber 21 and is in communication with each of the nozzle openings 11 and is in communication with each of the orifices 23 that are ink supply ports. And, a bottom wall of the discharge chamber 21 (concave portion 25) is a diaphragm 22 for discharging inkdrops.

The concave portion 26 forms a narrow groove-like orifice 23, and through this concave portion 26, the concave portion 25 (the discharge chamber 21) is in communication with the concave portion 27 (reservoir 24).

The concave portion 27 is for storing a liquid material such as an ink and forms a common reservoir (common ink chamber) 24 for the respective discharge chambers 21. And, the reservoir 24 (the concave portion 27) is in communication with all of the discharge chambers 21 through the respective orifices 23. In addition, the orifice 23 (the concave portion 26) may be provided on the back surface of the nozzle substrate 1 (the surface of the side bonded to the cavity substrate 2). Moreover, on the bottom of the reservoir 24, an opening passing through the after-described electrode substrate 3 is provided, and through an ink supply opening 34 that is this opening, an ink is supplied from an ink cartridge as not shown.

Moreover, on the entire surface of the cavity substrate 2, an insulator film 28, for example, consisting of a SiO₂ film with a film thickness of 0.1 μm formed by thermal oxidation. This insulator film 28 is provided in order to prevent dielectric breakdown or short circuit when the inkjet head is driven.

The electrode substrate 3 is produced from, for example, a glass substrate having a thickness of approximately 1 mm. As the glass substrate, it is appropriate to use a boron-silicon based heat-resistant hard glass having a coefficient of thermal expansion near to that of the silicon substrate of the cavity substrate 2. This is because as coefficients of thermal expansion of both of the substrates are near, stress to be generated between the electrode substrate 3 and the cavity substrate 2 can be reduced during anodically bonding the both substrates. Consequently, the electrode substrate 3 and the cavity substrate 2 can be bonded firmly without causing a problem such as separation. In addition, for the same reason, a boron-silicon based glass substrate can be used for the nozzle substrate 1, too.

On the electrode substrate 3, a concave portion 32 is provided at a position opposite to each of the diaphragms 22 of the cavity substrate 2. The concave portion 32 is formed by etching, for example, with a depth of approximately 0.3 μm. And, in each of the concave portions, an individual electrode 31 made of ITO (Indium Tin Oxide) is formed, for example, with a thickness of 0.1 μm. Therefore, a gap (airspace) formed between the diaphragm 22 and the individual electrode 31 becomes determined by, a depth of the concave portion 32, a thickness of the individual electrode 31, and a thickness of the insulator film 28 covering the diaphragm 22. This gap greatly influences discharge characteristic of the inkjet head, and therefore is formed high-precisely.

The individual electrode 31 has a lead portion 31a and a terminal portion 31b that is connected to a flexible wiring substrate (not shown). As shown in FIGS. 1 to 3, the terminal portions 31b are exposed to inside of an electrode taking-out portion 30 where the distal part of the cavity substrate 2 is opened for wiring.

As described above, as shown in FIG. 2, the nozzle substrate 1, the cavity substrate 2, and the electrode substrate 3 are bonded together, and thereby a main body of the inkjet head 10 is produced. That is, the cavity substrate 2 and the electrode substrate 3 are bonded by anodic bonding, and the nozzle substrate 1 is then boned to the upper surface (the upper face in FIG. 2) of the cavity substrate 2 by adhesion or the like. Furthermore, open ends of a gap formed between the diaphragm 22 and the individual electrode 31 are sealed air-tightly with a sealing material 35 made of resin such as epoxy. Thereby, moisture or dust can be prevented from entering the gap between electrodes and reliability of the inkjet head 10 can be maintained to be high.

Last, as simplified and shown in FIGS. 2 and 3, a drive control circuit 5 such as driver IC is connected to the respective terminal portions 31b of the individual electrodes 31 and to a common electrode 29 provided on the cavity substrate 2, through the above-described flexible wiring substrate (not shown).

As described above, the inkjet head 10 is completed.

Next, operation of the inkjet head 10 formed as described above will be explained.

The drive control circuit 5 is an oscillation circuit for controlling supply or stop of electric charge to the individual electrodes 31. This oscillation circuit oscillates, for example, at 24 kHz, and applies pulse electric potentials of, for example, 0V and 30V to the individual electrodes and thereby to supply electric charge. When the oscillation circuit is driven and electric charge is supplied to the individual electrode 31 so as to be charged positively, the diaphragm 22 is negatively charged and an electrostatic force (coulomb force) is generated between the individual electrode 31 and the diaphragm 22. Therefore, by this electrostatic force, the diaphragm 22 is pulled toward the individual electrode 31 and bowed down (displaced). Thereby, the volume of the discharge chamber 21 is increased. And, when the supply of electric charge to the individual electrode 31 is stopped, the diaphragm 22 turns back with its elastic force. At this time, the content of the discharge chamber 21 is rapidly decreased, and therefore by pressure at the time, a part of ink in the discharge chamber 21 is discharged as an inkdrop from the nozzle opening 11. Next, when the diaphragm 22 is displaced similarly, ink is supplemented in the discharge chamber 21 from the reservoir 24 through the orifice 23.

The inkjet head 10 of the present embodiment has an extremely stable discharge characteristic because, as described above, the nozzle opening 11 is formed to comprise, the jet orifice portion 11a of a tubular shape perpendicular to the surface (discharge surface) of the nozzle substrate 1, and the feed port portion 11b that is provided on the same axis as the jet orifice portion 11a and has a larger diameter than that of the jet orifice portion 11a, and therefore the inkdrops can be discharged straightly in the central axis direction of the nozzle opening 11.

Furthermore, because the cross-sectional shape of the feed port portion 11b can be a circular shape or a quadrangular shape, the inkjet head 10 can be planned to have higher density.

In addition, a cross-sectional shape of the jet orifice portion 11a and the feed port portion 11b of the nozzle opening 11 are not particularly limited and can also be formed to be a polygonal shape or a circular shape. However, a circular shape is preferable because it is advantageous in an aspect of discharge characteristic or processing characteristic.

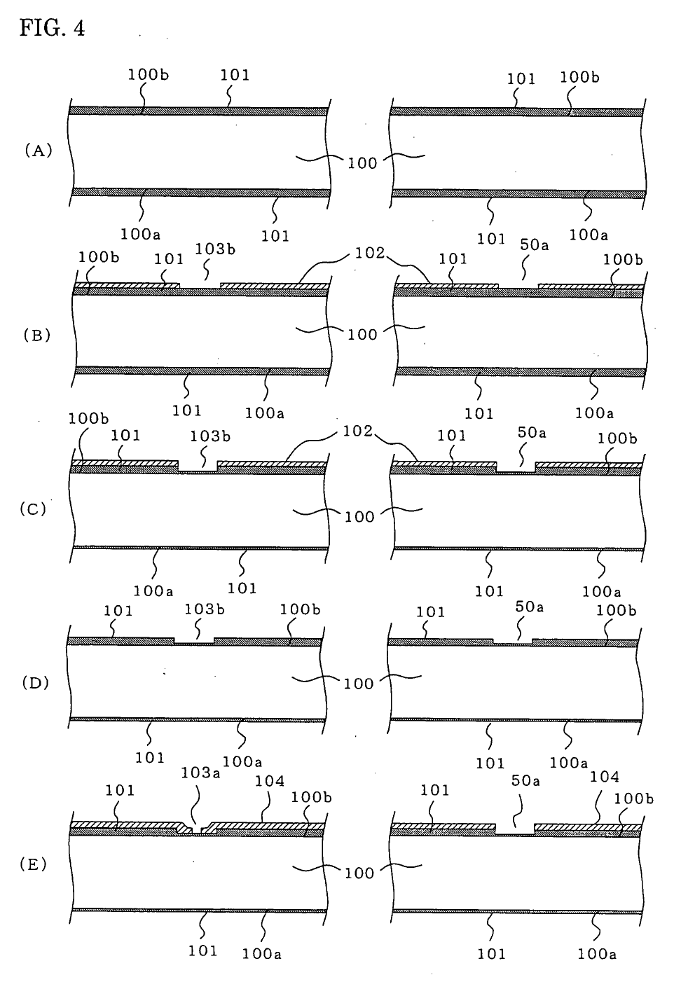

Next, one example of the method for producing the inkjet head 10 will be explained with reference to FIGS. 4A to 10V.

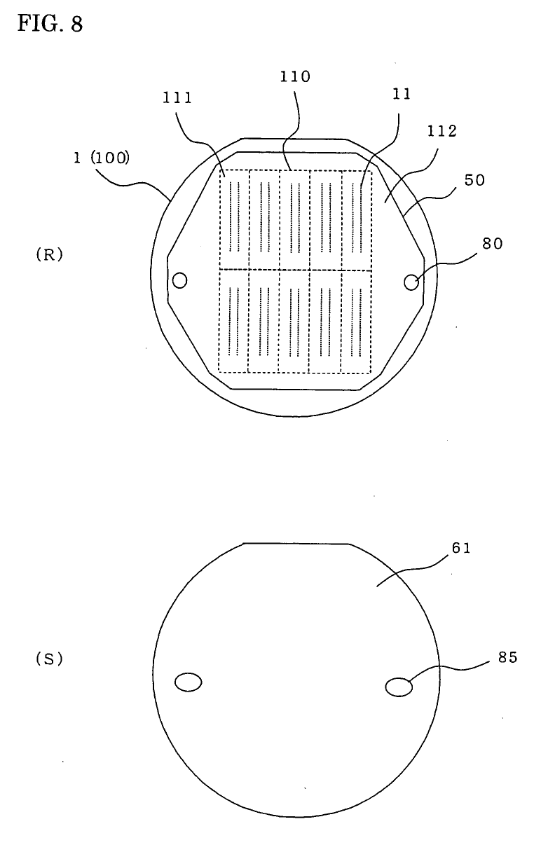

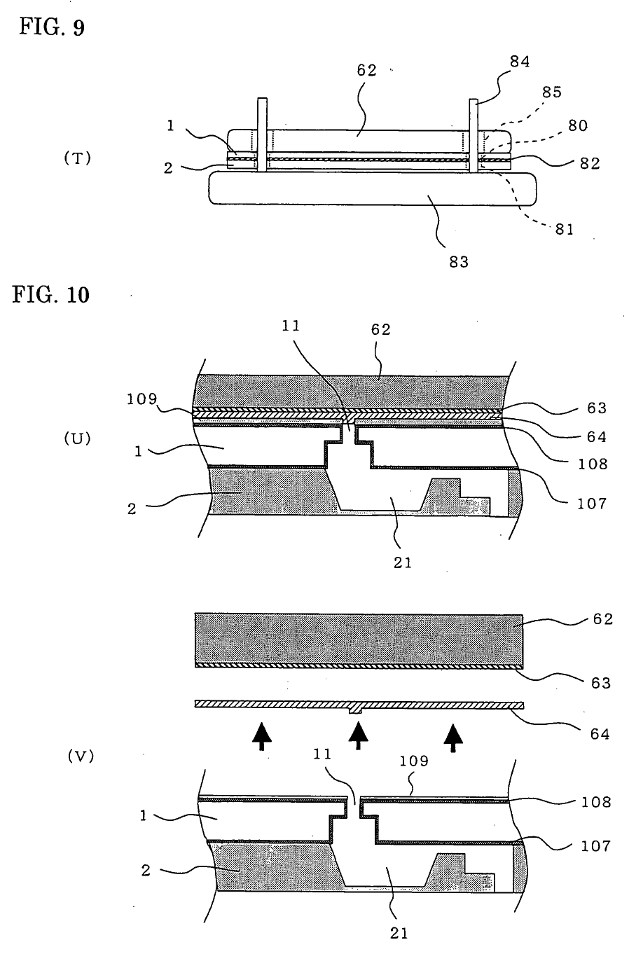

FIGS. 4A to 7Q are partially sectional views of a nozzle substrate in production steps showing the method for producing the nozzle substrate 1. In these figures, left side views show section of the nozzle opening portion formed on the processed substrate, and right side views show section of the peripheral groove portion formed at the same time as the nozzle opening portion. Moreover, FIG. 8R is a back surface view of the nozzle substrate 1 on which the peripheral groove 50 is formed, and FIG. 8S is an upper surface view of the first support substrate 61. Moreover, FIGS. 9T to 10V show a bonding step of the nozzle substrate 1 and the cavity substrate 2, and among them, FIG. 9T shows a side view of an alignment jig for positioning. In addition, in order to facilitate understanding, the nozzle substrate 1 and the cavity substrate 2 are shown in these figures so that one nozzle opening portion in one head chip 111 is enlarged and shown.

The peripheral groove 50 is formed so as to surround the whole of a head-forming region 110 in which a plurality of head chips 111 are formed, for example, as shown in FIG. 8R.

### (1) Method for Producing the Nozzle Substrate 1

First, the method for producing the nozzle substrate 1 will be explained. In addition, because the peripheral groove 50 is treated and processed similarly to the nozzle opening portion, explanation of the peripheral groove portion will be omitted as long as it is not particularly mentioned.

As the processed substrate, for example, a silicon substrate 100 with a thickness of 280 μm of which both surfaces are polished is prepared, and on the entire surface of the silicon substrate 100, a SiO₂ film 101 with a film thickness of 1 μM is formed uniformly (FIG. 4A). This SiO₂ film 101 is formed, for example, by setting the silicon substrate 100 in a thermal oxidation apparatus and performing a thermal oxidation treatment at an oxidizing temperature of 1075° C. in a mixed atmosphere of oxygen and water vapor for 4 hours. The SiO₂ film 101 is used as an etching resistant material of silicon.

Next, a resist 102 is applied on the SiO₂ film 101 formed on one surface (the surface of the side to be bonded to the cavity substrate 2, hereinafter, also called as the surface of the bonded side) 100b of the silicon substrate 100, a portion 103b to be the feed port portion 11b of the nozzle opening 11 is patterned to remove the resist 102 in the part 103b of the pattern (FIG. 4B). Moreover, 50a is an open portion on which the resist 102 is removed at a part to be the peripheral groove 50.

And, the SiO₂ film 101 is half etched with, for example, a buffered hydrofluoric acid aqueous solution in which a hydrofluoric acid aqueous solution and an ammonium fluoride aqueous solution are mixed at a ratio of 1:6, and thereby the SiO₂ film 101 at the portion 103b to be the feed port portion 11b is thinned (FIG. 4C). At this time, the SiO₂ film 101 on the surface (the surface of the discharge side, namely, the discharge surface) 100a on which the resist 102 is not formed is also etched to be thinner.

Then, the above-described resist 102 is removed by rinsing with sulfuric acid or the like (FIG. 4D).

Again, a resist 104 is applied on the SiO₂ film 101 formed on the surface 100b of bonding side of the silicon substrate 100, and a portion 103a to be the jet orifice portion 11a of the nozzle opening 11 is patterned to remove the resist 104 at the part 103a (FIG. 4E). The part 50a to be the peripheral groove 50 is patterned to have a same groove width (for example, 30 μm).

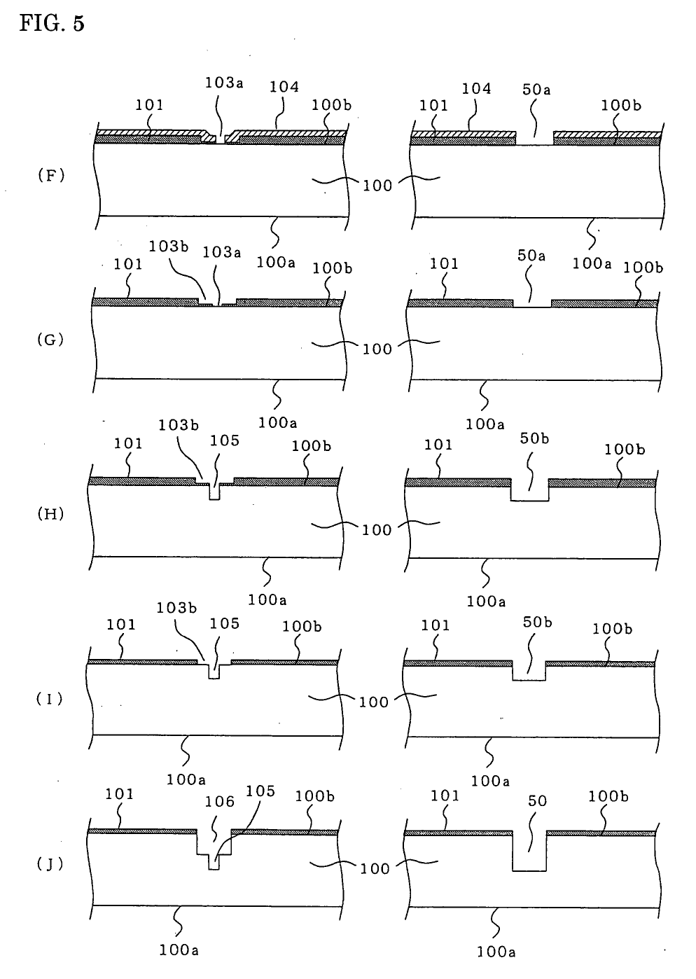

And, the SiO₂ film 101 is etched with, for example, a buffered hydrofluoric acid aqueous solution in which a hydrofluoric acid aqueous solution and an ammonium fluoride aqueous solution are mixed at a ratio of 1:6, and thereby the SiO₂ film 101 at the portion 103a to be the jet orifice portion 11a is opened (FIG. 5F). At this time, the SiO₂ film 101 on the surface 100a of the discharge side opposite thereto is completely etched to be removed.

Then, the above-described resist 102 is removed by rinsing with sulfuric acid or the like (FIG. 5G).

Next, the open portion of the SiO₂ film 101 is anisotropic-dry-etched perpendicularly by dry etching with ICP (Inductively Coupled Plasma) electric discharge, for example, at a depth of 25 μm, thereby to form a first concave portion 105 to be the jet orifice portion 11a of the nozzle opening 11 (FIG. 5H). In this case, as the etching gas, for example, C₄F₈ (carbon fluoride) and SF₆ (sulfate fluoride) are used, and these etching gases may be alternately used. Here, C₄F₈ is used in order to protect the side surface of the first concave portion 105 so as to prevent etching from progressing in the direction of the side surface of the first concave portion 105 and SF₆ is used to promote etching in the perpendicular direction of the first concave portion 105. 50b is a portion to be the peripheral groove to be formed at this step.

Next, in order that only the SiO₂ film 101 at the portion 103b to be the feed port portion 11b of the nozzle opening 11 is made to disappear, a half etching is performed with, for example, a buffered hydrofluoric acid aqueous solution in which a hydrofluoric acid aqueous solution and an ammonium fluoride aqueous solution are mixed at a ratio of 1:6 (FIG. 5I).

And, again, the open portion of the SiO₂ film 101 is anisotropic-dry-etched perpendicularly by dry etching with ICP electric discharge, for example, at a depth of 40 μm, thereby to form a second concave portion 106 to be the feed port portion 11b (FIG. 5J). Moreover, at this time, the peripheral groove 50 is formed at a depth of approximately 65 μm. Incidentally, there is no problem as long as the depth of the peripheral groove 50 is larger than a thickness of the silicon substrate obtained in the after-described thinning operation of the silicon substrate 100.

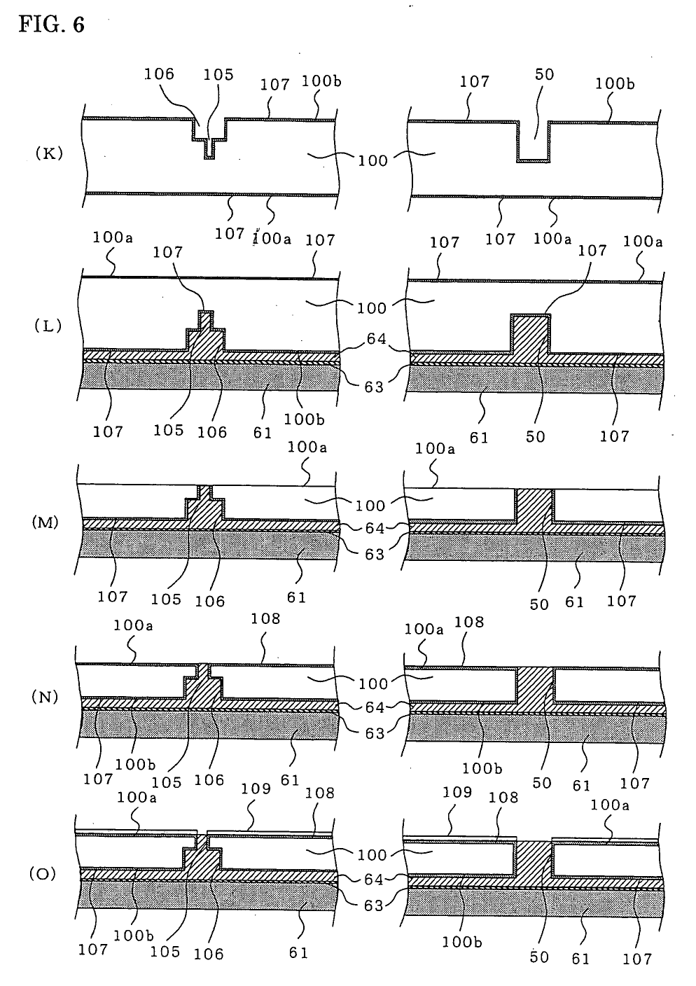

Next, after removing the SiO₂ film 101 left on the silicon substrate 100 with a hydrofluoric acid aqueous solution, the silicon substrate 100 is set in a thermal oxidization apparatus, and a thermal oxidation treatment is performed under the condition of an oxidizing temperature of 1000° C. and an oxidizing time of 2 hr and in a mixed atmosphere of oxygen and water vapor, and thereby the SiO₂ film 107 of a film thickness of 0.1 μm is formed uniformly on the side surfaces and the bottom surfaces of the first concave portion 105 to be the jet orifice portion 11a and the second concave portion 106 to be the feed port portion 11b that have been processed by the ICP dry etching apparatus (FIG. 6K).

Next, on the first support substrate 61 made of a transparent material such as glass, a separation layer 63 is spin-coated, and a resin layer 64 is spin-coated thereon. And, the surface that is coated with the separation layer 64 and the resin layer 64 on the support substrate 61 is faced to the surface on which the first concave portion 105 and the second concave portion 106 of the silicon substrate 100 is formed, and during a softened state of the resin of the resin layer 64, the first support substrate 61 and the silicon substrate 100 are bonded, for example, in vacuum under a vacuum pressure of 0.1 to 0.2 Pa (FIG. 6L). Then, by subjecting the inside of the vacuum chamber to atmospheric release, the resin in a softened state is filled inside the first concave portion 105 and the second concave portion 106. Then, the resin layer 64 is hardened. By bonding the support substrate 61 and the silicon substrate 100 in vacuum as described above, the resin can be completely filled in the first concave portion 105 and the second concave portion 106, and thereby an air bubble or the like can be prevented from staying. Incidentally, the separation layer 63 and the resin layer 64 will be described later.

From the side of the discharge surface 100a of the silicon substrate 100, polishing processing is performed by a back grinder, a polisher, a CMP (Chemical Mechanical Polishing) apparatus, or the like, and the SiO₂ film 107 is removed at the end of the first concave portion 105, and the silicon substrate 100 is thinned (made to be a thin plate) so that the end portion is opened (FIG. 6M). Incidentally, at this time, preferably, the silicon substrate 100 is ground up to the vicinity of the SiO₂ film 107 at the end of the first concave portion 105, for example, by a back grinder, and to make a thin plate, and then, the finishing therefor is performed by a polisher or a CMP apparatus. Thereby, the surface of the silicon substrate 100 can be finished high-precisely in a mirror surface. Furthermore, this thinning step, the inside of the first concave portion 105 and the second concave portion 106 are filled with the resin of the resin layer 64 and thereby to be protected. Therefore, for example, a polishing material does not enter the inside of the first concave portion 105 and so forth after the CMP processing. Therefore, a water rinse step for removing the polishing material or the like is not required. Moreover, as another method for making the silicon substrate 100 a thin plate, the end portion of the first concave portion 105 may be opened by dry etching. In this case, it is possible that, for example, by dry etching using SF₆ as the etching gas, the silicon substrate 100 is thinned up to the vicinity of the end portion of the first concave portion 105, and after the SiO₂ film 107 at the end portion of the first concave portion 105 is exposed on the surface, the SiO₂ film 107 is removed by dry etching using CF₄, CHF₄, or the like as the etching gas. Moreover, at this time, the resin layer 64 functions as a stop layer for the etching.

By the thinning process of the silicon substrate 100, the length of the nozzle opening 11 can be optimized.

Next, on the ink discharge surface of the silicon substrate 100, an ink-resistant protective film 108 is formed with a thickness of 0.1 μm by a sputtering apparatus (FIG. 6N). Here, it is sufficient that the formation of the SiO₂ film can be operated at the temperature (approximately 200° C.) or less at which the resin layer 64 is not degraded. The method is not limited to the sputtering method. However, considering ink-resistance property or so forth, an elaborate film needs to be formed. It is desirable to use an apparatus being capable of forming an elaborate film at a room temperature, such as an ECR (Electron Cyclotron Resonance) sputtering apparatus.

Next, the surface of the ink-resistant protective film 108 of the silicon substrate 100 is subjected to an ink repellent treatment. For example, the material with ink repellent property containing a fluorine atom is film-formed by vapor deposition, dipping, or the like, and thereby an ink repellent film 109 is formed (FIG. 6O). At this time, the inside of the first concave portion 105 and the second concave portion 106 are filled with the resin of the resin layer 64 and are protected, and therefore only the surface of the discharge surface is selectively subjected to the ink repellent treatment.

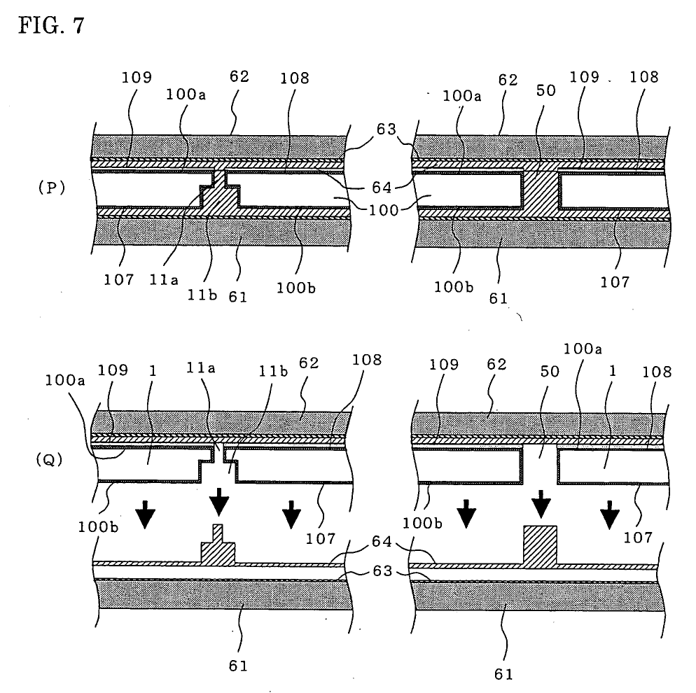

Next, a second support substrate 62 is attached to the discharge surface subjected to the ink repellent treatment, through the separation layer 63 and the resin layer 64 by the same manner as the above-described FIG. 6L (FIG. 7P). At this time, as shown in FIG. 8S, on the second support substrate 62, an escape opening 85 for an alignment pin for positioning is opened. The diameter of the escape opening 85 is designed to be larger than the diameter of an alignment opening 80 for positioning that is opened in the silicon substrate 100 by etching, and in the bonding, the escape opening 85 is disposed so that the alignment pin for positioning does not interfere with the support substrate 62 during bonding. Moreover, on the silicon substrate 100, as shown in FIG. 8R, when the nozzle opening 11 having the jet orifice portion and the feed port portion is processed, the peripheral groove 50 is formed at the same time on the substrate peripheral part separate from the head-forming region 110.

Next, a laser light is applied from the side of the first support substrate 61, and thereby the support substrate 61 is separated from the part of the separation layer. Subsequently, by using an adhesive tape or the like, the resin layer 64 is slowly peeled away from the peripheral part and thereby the resin layer 64 is peeled off from the silicon substrate 100 (FIG. 7Q). At the time, if the resin inside the nozzle opening 11 cannot be completely pulled away and the resin is left in the nozzle opening, the residual resin is ashed with an oxygen plasma and removed.

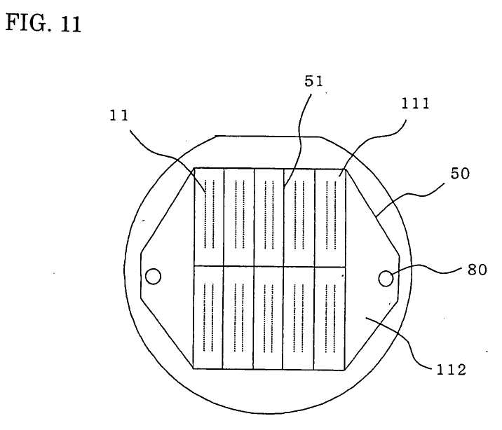

When this support substrate 61 or the resin layer 64 is separated from the silicon substrate 100, the silicon substrate 100 is pulled by the support substrate 61 or the resin layer 64 and a crack is generated from the substrate peripheral part, occasionally. However, in the peripheral part of the silicon substrate 100, as shown in FIG. 8R, the peripheral groove 50 is formed so as to surround the whole of a head-forming region 110 on which a plurality of head chips 111 are formed, for example, as shown in FIG. 8R, and therefore, the crack can be prevented from progressing at the part of this peripheral groove 50. Therefore, the crack does not reach the head-forming region 110, and the silicon substrate 100 in itself does not come to break. Moreover, since the peripheral groove 50 is formed outside the alignment opening, the alignment opening 80 is not cracked by the crack caused during separation, and therefore alignment precision can be ensured. Moreover, for example, as shown in FIG. 11, a chip outside groove 51 may be formed so as to be along a periphery of each of the individual head chips 111. Its effect is the same. In the case that the cavity substrate can be chipped by break or the like without using dicing, it is desirable that the chip outside groove 51 is formed along the head chip outside shape in order to prevent a chip and a break of the nozzle substrate.

By going through steps as described above, the nozzle substrate 1 in the state of being bonded to the second support substrate 62 can be formed.

Next, with reference to FIGS. 9T to 10V, there will be described in detail the step of bonding the nozzle substrate 1 produced as described above, and the cavity substrate 2 on which the concave portion 25 to be the discharge chamber 21, the concave portion 27 to be the reservoir 24, and so forth, are preliminarily produced.

On the nozzle substrate 1 (the silicon substrate 100), as shown in FIG. 8R, the alignment opening 80 for positioning is formed on the same substrate coordinate axis as the alignment opening 81 for positioning of the cavity substrate 2 (FIG. 9T). And, on the adhesion surface 112 of the nozzle substrate 1 bonded to the second support substrate 62, the adhesive layer 82 is applied with a thickness of 1 to 2 μm.

FIG. 9T shows a state that, the nozzle substrate 1 and the cavity substrate 2 are bonded on the alignment jig 83 for positioning. The nozzle substrate 1 and the cavity substrate 2 are adhered by adjusting the alignment openings 80 and 81 for positioning that are opened on the same axis as an alignment pin 84 for positioning, and then are bonded at a bonding load of 0.1 to 0.3 MPa in a special bonding jig (FIG. 10U). At this time, the escape opening 85 is formed on the second support substrate 62 of the nozzle substrate 1 so that the alignment pin 84 for positioning does not interfere therewith (FIGS. 8S and 9T).

And, last, a laser light is applied from the side of the second support substrate 62, and the second support substrate 62 is separated from the part of the separation layer 63, and subsequently, the resin layer 64 is peeled off the nozzle substrate 1 (FIG. 10V). At this time, the part of the nozzle substrate 1 outside the peripheral groove 50 is removed together with the resin layer 64. Incidentally, the adhesion and separation of the resin layer 64 does not damage the ink repellent film 109 on the surface of the nozzle substrate 1.

In the above-described embodiment, for bonding the silicon substrate 100 and each of the support substrates 61 and 62, the resin layer 64 and the separation layer 63 are used. Here, the resin layer 64 is used to absorb irregularities of the surface of the silicon substrate 100 and thereby to bond the silicon substrate 100 and the support substrates 61 and 62. The separation layer 63 is used for separating each of the support substrates 61 and 62 after the predetermined treatment steps. In this case, it is preferable that the support substrates 61 and 62 have a light transmission property, and for example, a glass can be used. Thereby, when each of the support substrates 61 and 62 is separated from the silicon substrate 100, the light having a separation energy applied on the back surface of each of the support substrates 61 and 62 can be made to certainly reach the separation layer 63.

The resin layer 64 is not particularly limited as long as it has a function of bonding the silicon substrate 100 and each of the support substrates 61 and 62, and a various types of resins can be used. More specially, for example, the resin such as an hardening adhesive agent, such as an adhesive agent with a thermo-setting property, an adhesive agent with a light-setting property, or the like. Moreover, it is preferable that the resin layer is formed so that a main material thereof is a material with a high dry-etching resistance. Thereby, when the nozzle opening 11 is formed by etching the silicon substrate 100, the resin layer can be a stop layer of the etching, and the silicon substrate 100 can be completely passed through, and thereby the nozzle opening 11 can be formed. Moreover, in the processing, the resin layer also has an action of buffering the stress generated between the silicon substrate 100 and each of the support substrates 61 and 62 by the difference of coefficients of thermal expansion thereof due to the difference of materials thereof.

The separation layer 63 has a function of generating separation inside the separation layer or in the interface of the silicon substrate and the separation layer (also referred to as in-layer separation or interface separation) by being subjected to light such as laser light. That is, the separation layer is subjected to a light having certain intensity, and thereby, an interatomic or intermolecular bonding force in the atoms or the molecules of the constituent material thereof is made to disappear or to decrease, and ablation or the like is generated to make it easy to generate the separation. Moreover, by being subjected to a light having certain intensity, the separation layer occasionally leads to separation by the cause where a component in the constituent material of the separation layer becomes a gas and is released, or where the separation layer absorbs the light and becomes a gas and a vapor thereof is released. Thereby, the nozzle substrate 1 made to be a thin type can be removed from the support substrates 61 and 62.

Specifically, the material forming the separation layer is not particularly limited as long as it has the above-described function. However, it is possible to exemplify amorphous silicon (a-Si), silicon oxide or silicon compound, silicon nitride, aluminum nitride, ceramic nitride such as titanium nitride, organic polymeric materials (whose interatomic bond can be broken by irradiation with a light), metal such as Al, Li, Ti, Mn, In, Sn, Y, La, Ce, Nd, Pr, Gd, or Sm, or alloy containing at least one kind of the metals. Among them, it is particularly preferable to use amorphous silicon (a-Si), and it is preferable that in the amorphous silicon, hydrogen (H) is contained. Thereby, by subjecting the separation layer to a light, the hydrogen is released, and an internal pressure is generated in the separation layer, so that the separation can be promoted. In this case, it is preferable that the content of the hydrogen in the separation layer is approximately 2 at % or more, and more preferably, 2 to 20 at %. Moreover, the content of the hydrogen can be controlled by setting appropriately the conditions for forming the separation layer that are, for example, in the case in which a CVD method is used, the gas composition, the gas pressure, the gas atmosphere, the gas flow amount, the gas temperature, the substrate temperature, the pumping power, and so forth.

Incidentally, though the resin layer and the separation layer are separate layers in the above-described explanation, these layers may be brought together to be one layer. That is, it is possible to use a layer, which has an adhesive force (bonding force) and an action of causing the separation by light or heat energy or the like (the action of lowering the bonding force), to bond the silicon substrate 100 and each of the support substrates 61 and 62. In this case, for example, a technique described in Japanese Unexamined Patent Application Publication No. 2002-373871 is applicable.

As described above, according to the method for producing a nozzle substrate 1 of the present embodiment, on the silicon substrate 100 in which the portion of the nozzle opening 11 is formed, the peripheral groove 50 is formed so as to surround the whole of a head-forming region 110 in which a plurality of head chips 111 are formed. And, the second support substrate 62 is stuck on the discharge surface side of the silicon substrate 100. Therefore, when the first support substrate 61 is separated from the silicon substrate 100 and the resin layer 64 is subsequently peeled off therefrom, a crack from a chip or break can be prevented from reaching the head chip portion at the part of this peripheral groove 50. Also, after separating the first support substrate 61 from the silicon substrate 100, the silicon substrate 100 is held by the second support substrate 62. Therefore, handing is easy and the silicon substrate 100 does not break. Accordingly, there is an effect of significant improvement of yield and productivity in the production of the nozzle substrate 1.

Moreover, as shown in FIG. 11, by forming the chip outside groove 51 along a periphery of each of the individual head chips 111, the substrate can be chipped by break or the like without using dicing.

### (2) Method for Producing the Cavity Substrate 2 and the Electrode Substrate 3

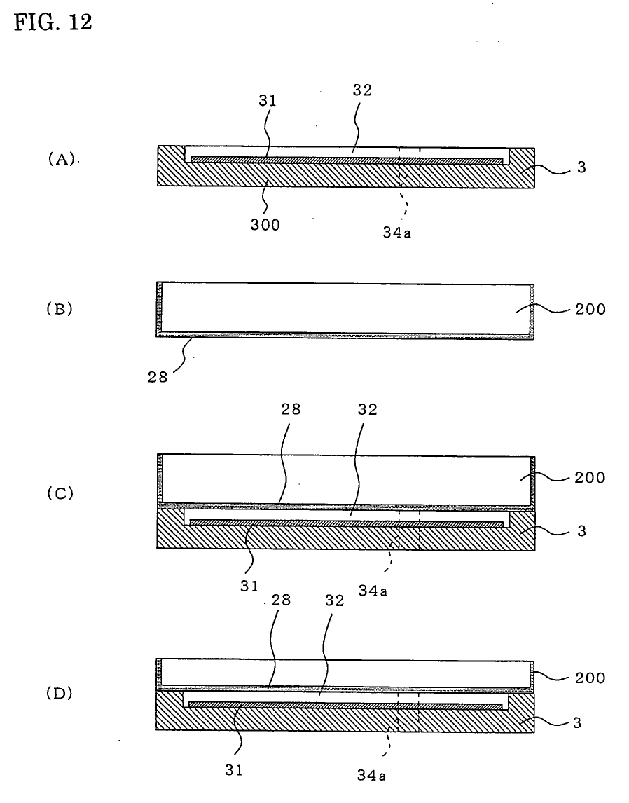

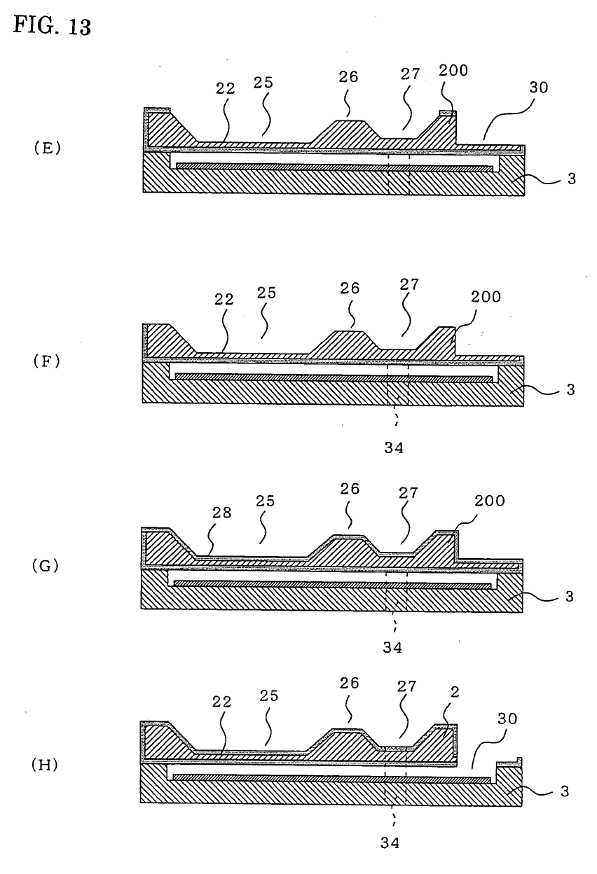

Here, with reference to FIGS. 12A to 13H, a method for producing the cavity substrate 2 from a silicon substrate 200 after being bonded to the electrode substrate will be explained simply.

The electrode substrate 3 is produced as follows.

First, a glass substrate 300 with a plate thickness of approximately 1 mm made of boron-silicon glass or the like is etched, for example, with hydrofluoric acid by using an etching mask of gold or chromium, and thereby a concave portions 32 are formed. Incidentally, each of concave portions 32 has a groove shape being a little larger than the shape of the individual electrode 31, and a plurality of the concave portions 32 are formed for the respective individual electrodes 31.

And, inside each concave portion 32, an ITO (Indium Tin Oxide) film is formed with a thickness of 1 μm, for example, by sputtering, and subsequently, this ITO film is patterned by photolithography. Thereby the portion except the portion to be the individual electrode 31 is etched and removed, so that the individual electrode 31 is formed inside the concave portion 32.

Then, an opening part 34a to be an ink supply opening 34 is formed by blast processing or the like, and thereby the electrode substrate 3 is produced (FIG. 12A).

Next, after both sides of the silicon substrate 200 with a thickness of, for example, 525 μm, are mirror-polished, a silicon oxide film (insulator film) 28 made of TEOS with a thickness of 0.1 μm is formed by Plasma CVD (Chemical Vapor Deposition) (FIG. 12B). Incidentally, before forming the silicon substrate 200, a boron doped layer may be formed by utilizing an etching stop technique, in order to high-precisely form the thickness of the diaphragm 22. The etch stop is defined as a state that generation of air bubbles from the etched surface is stopped. In the actual wet etching, the etching is determined to be stopped by the stop of generation of bubbles.

And, this silicon substrate 200 and the electrode substrate 3 as produced as shown in FIG. 12A are heated, for example, at 360° C., and the silicon substrate 200 is connected to an anode electrode and the electrode substrate 3 is connected to a cathode electrode, and a voltage of approximately 800 V is applied, so that the bonding is performed by anodic bonding (FIG. 12C).

After the silicon substrate 200 and the electrode substrate 3 are anodically bonded, the silicon substrate 200 in a bonding state is etched with a potassium hydroxide aqueous solution or the like, and thereby the silicon substrate 200 is made a thin to a thickness of, for example, 140 μm (FIG. 12D).

Next, on the whole surface of the upper surface (the surface opposite to the surface bonded to electrode substrate 3) of the silicon substrate 200, a TEOS film, for example, of a thickness of 0.1 μm is formed by Plasma CVD.

And, a resist is patterned in order to form, on this TEOS film, the concave portion 25 to be the discharge chamber 21, the concave portion 26 to be the orifice 23, and the concave portion 27 to be the reservoir 24. And, the TEOS film is etched and removed in the patterned portions.

Then, by etching the silicon substrate 200 with a potassium hydroxide aqueous solution or the like, and thereby, each of the above-described concave portions 25 to 27 is formed (FIG. 13E). At this time, a portion to be an electrode taking-out portion 30 for wiring is also etched to be thinner. Incidentally, at a step of the wet etching of FIG. 13E, it is possible that, for example, first, a 35-wt % potassium hydroxide aqueous solution is used, and then, a 3-wt % potassium hydroxide aqueous solution is used. Thereby, surface roughness of the diaphragm 22 can be suppressed.

After the etching of the silicon substrate 200, the TEOS film formed on the upper surface of the silicon substrate 200 is removed by etching with a hydrofluoric acid (FIG. 13F).

Next, on the surface, on which the concave portion 25 to be the discharge chamber 21 and so forth are formed, of the silicon substrate 200, a TEOS film (insulator film 28) is formed by Plasma CVD, for example, with a thickness of 1 μm (FIG. 13G)

Then, the electrode take-out portion 30 is opened by a RIE (Reactive Ion Etching) dry etching or the like. Moreover, from the open portion to be the ink supply opening 34 of the electrode substrate 3, a laser processing or a blast processing is performed, so as to pass through the bottom of the concave portion 27 to be the reservoir 24 of the silicon substrate 200 and the ink supply opening 34 is formed (FIG. 13H). Moreover, open ends of a gap between the diaphragm 22 and the individual electrode 31 are sealed by filling a sealing material (not shown) made of epoxy resin or the like therein. Moreover, as shown in FIGS. 1 and 2, the common electrode 29 is formed at an end portion of the upper surface (the surface of the side bonded to the nozzle substrate 1) by sputtering.

As described above, the cavity substrate 2 is produced from the silicon substrate 200 in a bonded state to the electrode substrate 3.

And, last, after the nozzle substrate 1 produced as described above is bonded to this cavity substrate 2 by adhesion or so forth, the main body part (head chip) of the inkjet head 10 as shown in FIG. 2 is produced by dividing the cavity substrate 2 into the individual chips by dicing or so forth.

According to the method for producing the inkjet head 10, because the cavity substrate 2 is produced from a silicon substrate 200 in a state that the cavity substrate 2 is bonded to the electrode substrate 3 being preliminarily produced, the cavity substrate 2 is supported by the electrode substrate 3. Therefore, if the cavity substrate 2 is made thin, it is not broken or chipped, and handling becomes easy. Accordingly, yield is improved, compared with that of the case of singly producing the cavity substrate 2.

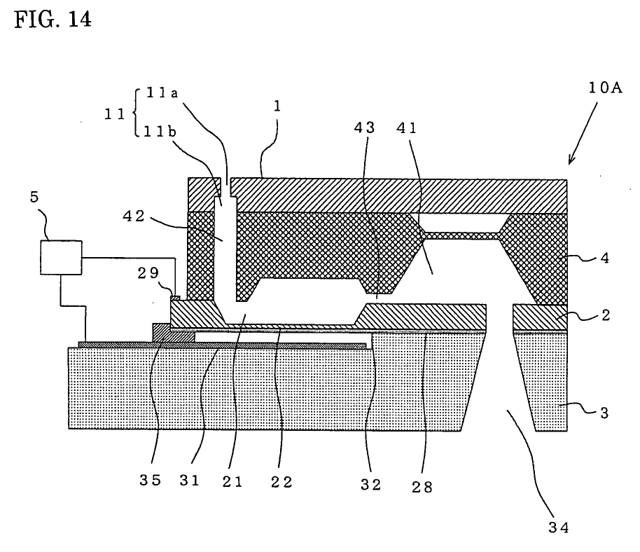

Next, another embodiment of the present invention is shown in FIG. 14. FIG. 14 shows an example of forming the inkjet head 10A by stacking four substrates. That is, this inkjet head 10A is formed by sandwiching and bonding a reservoir substrate 4 between the nozzle substrate 1 and the cavity substrate 2, and the nozzle substrate 1 is bonded to the reservoir substrate 4 by adhesion. Moreover, the reservoir substrate 4 is bonded to the cavity substrate 2 by adhesion. Accordingly, this reservoir substrate 4 is the third support substrate to bond the nozzle substrate 1. The other constitutions are almost the same as the above-described embodiment, and therefore, the explanations thereof will be omitted with applying to the same sign.

Moreover, this nozzle substrate 1 is produced by the same processing method as described above (see, FIGS. 4A to 8S). Incidentally, in the reservoir substrate 4, there is preliminarily formed, by wet etching, a reservoir 41, a nozzle communicating opening 42 being in communication with the feed port portion 11b of the nozzle opening 11, an orifice 43 in communication with the discharge chamber 21 of the cavity substrate 2, and so forth.

Moreover, as described above, the discharge chamber 21 and so forth are formed by wet etching or dry etching in the silicon substrate bonded to the electrode substrate 3 for the cavity substrate 2.

Also, in this embodiment, in the production of the nozzle substrate 1, the peripheral groove 50 is formed so as to surround the whole of the head-forming region 110 as shown in FIG. 8R, or the chip outside groove 51 is formed so as to be along a periphery of each of the individual head chips 111 as shown in FIG. 11. Therefore, when the resin layer 64 of the first support substrate 61 is separated, a crack does not reach the head chips 111.

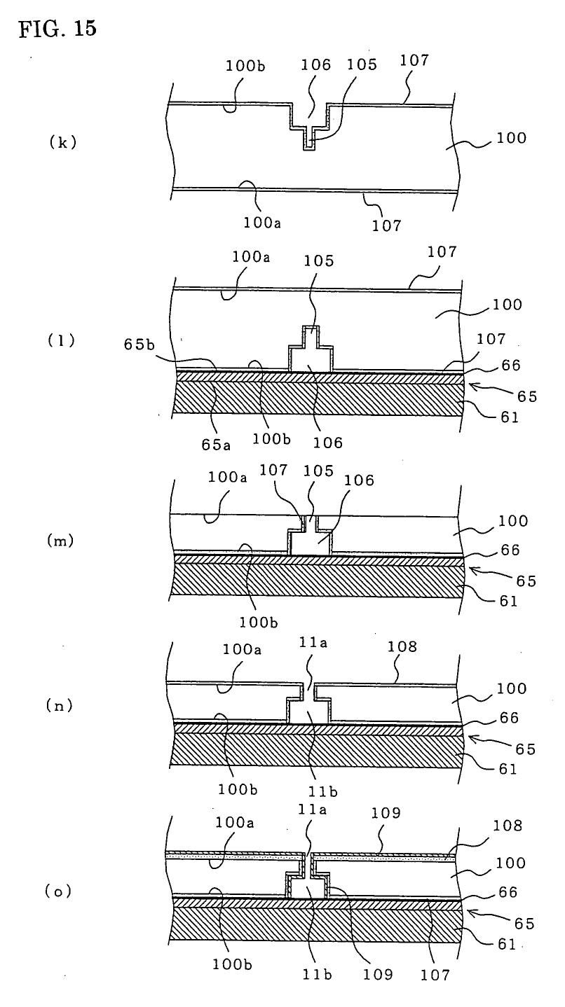

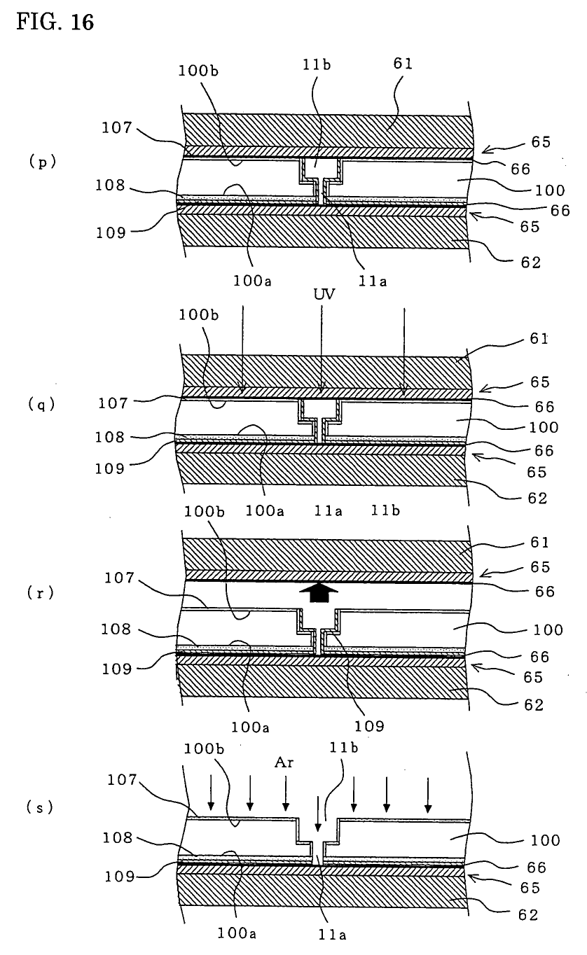

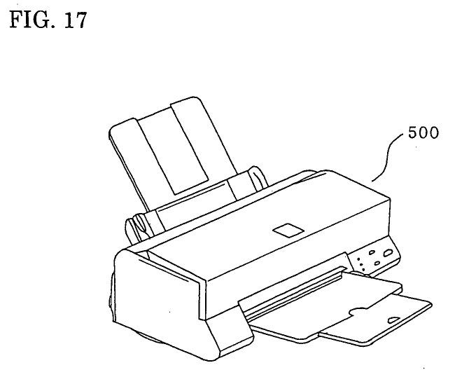

Next, another embodiment of the method for producing the nozzle substrate 1 of the present invention will be explained with reference to FIGS. 15K to 16S.

In the method for producing the nozzle substrate 1 of the present embodiment, as an adhesive member for sticking the first support substrate 61 and the second support substrate 62 to the silicon substrate 100, a double-sided adhesive sheet is used instead of the above-described resin material with a hardening property. Therefore, the steps for producing this nozzle substrate 1 is fundamentally the same as the previously-shown FIGS. 4A to 7Q. Here, sectional views in the steps after FIG. 15K that is the same as FIG. 6K are shown. Moreover, it is possible whether the peripheral groove 50 is provided, or not. However, it is more preferable to provide the groove because a chap does not reach the head chip when the double-stick sheet is delaminated. In addition, step section views for the peripheral groove 50 and explanations therefor are omitted because they are the same as described above.

As shown in FIG. 15K (the same as the FIG. 6K), the first concave portion 105 to be a jet orifice portion 11a the second concave portion 106 to be a feed port portion 11b are formed in the silicon substrate 100. On the internal walls of these concave portions 105, 106, a SiO₂ film 107 of a film-thickness of 0.1 μm is formed. Then, as shown in FIG. 15L, on the surface having the concave portions 105, 106 of this silicon substrate 100, the first support substrate 61 made of a transparent material such as glass is attached through a double-sided adhesive sheet 65. As the double-sided adhesive sheet 65, for example, Selfa BG (Registered Trademark of Sekisui Chemical Co., Ltd.) is used. The double-sided adhesive sheet 65 is a sheet having a self-separation layer 66 (self-separation type sheet), and has adhesive surfaces on both sides thereof, and further has the self-separation layer 66 on one surface thereof. The adhesive force of this self-separation layer 66 is lowered by stimulation such as ultraviolet light or heat.

In the present embodiment, the surface 65a consisting of only the adhesive surface of the double-sided adhesive sheet 65 is faced to a surface of the first support substrate 61, and the surface 65b on the side having the self-separation layer 66 of the double-sided adhesive sheet 65 is faced to the surface 100b of the bonded side of the silicon substrate 100, and they are bonded under a reduced pressure environment (10 Pa or less) such as in vacuum. In the manner as described above, the uniform adhesion becomes possible without leaving air bubbles on the adhesive interface. If air bubbles are left on the adhesive interface, variations in plate thicknesses of the silicon substrate 100 made thin in polishing processing is caused.

Incidentally, though the case that the self-separation layer 66 is provided only on one surface 65b of the double-stick sheet 65 has been shown in the above-described explanation, the self-separation layer 66 may be provided on the both surfaces 65a, 65b of the double-sided adhesive sheet 65. In this case, in the thinning process of the silicon substrate 100, the silicon substrate 100 can be processed in the state that the sheet is attached to the silicon substrate 100 and the support substrate 61 through both surfaces 65a, 65b having the self-separation layer, respectively. After the treatment, at the both surfaces 65a, 65b having the self-separation layer, the silicon substrate 100 and the support substrate 61 can be separated.

Next, as shown in FIG. 15M, the surface 100a of the ink discharge side of the silicon substrate 100 is ground by a back grinder (not shown), and thereby the silicon substrate 100 is thinned until the end of the first concave portion 105 is opened. Furthermore, the end portion of the first concave portion 105 may be opened by polishing the surface 100a of the ink discharge side by a polisher and a CMP apparatus. At this time, the internal walls of the first concave portion 105 and the second concave portion 106 are rinsed by a water rinse step for removing abrasive in the concave portions.

Alternatively, the end portion of the first concave portion 105 may be opened by dry etching. For example, by dry etching using SF₆ as the etching gas, the silicon substrate 100 is thinned to the end portion of the first concave portion 105, and then the SiO₂ film 107 at the end portion of the first concave portion 105 exposed to the surface may be removed by dry etching using CF₄, CHF₃, or the like.

Next, as shown in FIG. 15N on the surface 100a of the ink discharge side of the silicon substrate 100, a SiO₂ film is formed with a thickness of 0.1 μm as the ink repellent film 108 with a sputtering apparatus. Here, it is sufficient that the film formation of the SiO₂ film can be operated at the temperature, at which the double-stick sheet 65 are not degraded, (approximately 200° C.) or less. The method is not limited the sputtering method. However, considering ink-resistance or so forth, an elaborate film needs to be formed. It is desirable to use an apparatus being capable of forming an elaborate film at a room temperature, such as an ECR sputtering apparatus.

Subsequently, as shown in FIG. 15O, the surface 100a of the ink discharge side of the silicon substrate 100 is subjected to an ink repellent treatment. In this case, the material with ink repellent property containing a F atom is film-formed by vapor deposition or dipping, and thereby an ink repellent film 109 is formed. At this time, the internal walls of the jet orifice portion 11a and the feed port portion 11b of the nozzle opening 11 are also subjected to the ink repellent treatment.

Next, as shown in FIG. 16P (from here to FIG. 16S, states of the silicon substrate 100 are shown upside down in comparison with FIG. 15O), the surface 100a of the ink discharge side subjected to an ink repellent treatment is attached to the second support substrate 62 through the same double-sided adhesive sheet 65 as described above.

Next, as shown in FIG. 16Q, UV light is applied from the side of the first support substrate 61.

As described above, as shown in FIG. 16R, the self-separation layer 66 of the double-sided adhesive sheet 65 is separated from the surface 100b of the bonded side of the silicon substrate 100, and the first support substrate 61 is removed from the silicon substrate 100.

Next, as shown in FIG. 16S, the surface 100a of the ink discharge side of the silicon substrate 100 separated from the first support substrate 61 is subjected to Ar sputtering or O₂ plasma treatment, to remove the excess ink repellent film 109 on the internal walls of the jet orifice portion 11a and the feed port portion 11b of the nozzle opening 11.

By going through the above-described steps, it is possible to form the nozzle substrate 1 in a state of being bonded to the second support substrate 62 through the double-sided adhesive sheet 65. Incidentally, in some cases, though the self-separation layer 66 entering inside of the nozzle adheres to the ridge of the feed port portion 11b and is left thereon, it can be removed by rinsing with sulfuric acid or the like.

Then, by going through the same steps as the previously-shown FIGS. 9T to 13H, the ink jet head 10 can be produced.

According to the method for producing the inkjet head 10 of the present embodiment, when the silicon substrate 100 to be the nozzle substrate 1 is processed, it is sufficient only to bond the silicon substrate 100 and each of the first and the second support substrates 61, 62 through the double-sided adhesive 65. Therefore, a foreign matter such as adhesive resin does not get into the nozzle opening 11 of the silicon substrate 100. Therefore, when the double-sided adhesive sheet 65 is separated from the silicon substrate 100, a break or a chip is not generated. Accordingly, there are the effects that, handling of the silicon substrate 100 is easy, yield of the nozzle substrate 1 is improved, and thereby productivity is significantly improved.

In the above-described embodiments, the inkjet head, the nozzle substrate thereof, and the methods for producing them, are described. However, the present invention is not limited to the above-described embodiments, and can be variously modified in the scope of the present invention. For example, by modifying the liquid material to be discharged from the nozzle opening, the prevent invention can be utilized as not only the inkjet printer 500 as shown in FIG. 17 but also a droplet-discharging apparatus for various applications such as, production of a color filter of a liquid crystal display, formation of a light-emitting portion of an organic EL display apparatus, production of a microarray for biomolecular solutions to be used for a gene test or the like, and so forth.

1. A method for producing a nozzle substrate comprising:
a step of forming, by an etching process, a plurality of concave portions to be nozzle openings for discharging droplets, on a substrate to be processed;
a step of bonding a first support substrate to a surface of a process side of the processed substrate on which the concave portions are formed;
a step of subjecting the processed substrate to a thinning process from a surface opposite to a surface bonded to the first support substrate, so that the substrate has a desired thickness thereby opening an end of each of the concave portions;
a step of bonding a second support substrate to a surface of the opened side on which the end of each of the concave portions is opened;
a step of separating the first support substrate from the processed substrate and bonding a third support substrate to the separated surface of the substrate processed; and
a step of separating the second support substrate from the substrate processed.

2. A method for producing a nozzle substrate comprising:
a step of forming, by an etching process, a plurality of concave portions to be nozzle openings for discharging droplets and a peripheral groove, on a substrate to be processed;
a step of bonding a first support substrate to a surface of a process side of the processed substrate on which the concave portions and the peripheral groove are formed;
a step of subjecting the processed substrate to a thinning process from a surface an opposite to a surface bonded to the first support substrate, so that the substrate has a desired thickness thereby opening an end of each of the concave portions and the peripheral groove;
a step of bonding a second support substrate to a surface of the opened side on which the end of each of the concave portions and the peripheral groove is opened;
a step of separating the first support substrate from the substrate processed and bonding a third support substrate to the separated surface of the processed substrate; and
a step of separating the second support substrate from the substrate processed.

3. The method for producing a nozzle substrate according to claim 2, wherein the peripheral groove is formed in a peripheral part of the processed substrate so as to surround the entirety of a head-forming region on which a plurality of head chips are formed.

4. The method for producing a nozzle substrate according to claim 3, wherein the peripheral groove includes a chip outside groove formed along a periphery of each of the individual head chips.

5. The method for producing a nozzle substrate according to claim 3, wherein the peripheral groove is formed outside an alignment opening formed in the processed substrate.

6. The method for producing a nozzle substrate according to claim 1, wherein each of the first and the second substrates is bonded to the processed substrate through a double-sided adhesive sheet.

7. The method for producing a nozzle substrate according to claim 6, wherein the double-sided adhesive sheet has a self-separation layer whose adhesive force is lowered by applying ultraviolet light or heat to an adhesive surface thereof.

8. The method for producing a nozzle substrate according to claim 7, wherein the double-sided adhesive sheet has the self-separation layer on one surface thereof, and the processed substrate is attached to a side of the adhesive surface having the self-separation layer.

9. The method for producing a nozzle substrate according to claim 7, wherein the double-sided adhesive sheet has the self-separation layer on both surfaces thereof, and the processed substrate and each of the first and the second support substrates are attached to the adhesive surfaces having the self-separation layers.

10. The method for producing a nozzle substrate according to claim 6, wherein the processed substrate and each of the first and the second support substrates are bonded through the double-sided adhesive sheet under a reduced pressure environment.

11. The method for producing a nozzle substrate according to claim 1, wherein the processed substrate and each of the first and the second support substrates are bonded through a resin layer in vacuum.

12. The method for producing a nozzle substrate according to claim 11, wherein the resin layer adheres to the processed substrate, and adheres to each of the first and the second support substrates through a separation layer made of a material allowing segregation of the separation layer by irradiation of light.

13. The method for producing a nozzle substrate according to claim 6, wherein when the first support substrate is separated from the processed substrate, in the case in which an adhesive resin is left in each of the nozzle openings, the remaining adhesive resin is removed by performing a plasma treatment.

14. The method for producing a nozzle substrate according claim 1, wherein each of the nozzle openings is formed to have two stages of a jet orifice portion for discharging droplets and a feed port portion having a concentric shape with that of the jet orifice portion and a diameter larger than that of the jet orifice portion.

15. The method for producing a nozzle substrate according to claim 1, wherein each of the nozzle openings is formed by anisotropic dry etching with ICP electric discharge.

16. The method for producing a nozzle substrate according to claim 15, wherein the anisotropic dry etching is performed by using C₄F₈ and SF₆ as an etching gas.

17. A method for producing a droplet-discharging head, wherein in the method for producing a nozzle substrate according to claim 1, the third support substrate, to which the processed substrate is bonded, is a silicon substrate in order to form a cavity substrate having a flow pathway in communication with the nozzle opening or a reservoir substrate in which a flow pathway in communication with the nozzle opening is previously formed.

18. A head for discharging droplets, produced by a method comprising:
a step of forming, by an etching process, a plurality of concave portions to be nozzle openings for discharging droplets, on a substrate to be processed;
a step of bonding a first support substrate to a surface of a process side of the processed substrate on which the concave portions are formed;
a step of subjecting the processed substrate to a thinning process from a surface of an opposite side of a surface bonded to the first support substrate, so that the substrate has a desired thickness thereby opening an end of each of the concave portions;
a step of bonding a second support substrate to a surface of the opened side on which the end of each of the concave portions is opened;
a step of separating the first support substrate from the processed substrate and bonding a third support substrate to the separated surface of the processed substrate; and
a step of separating the second support substrate from the processed substrate.

19. A head for discharging droplets, produced by a method comprising:
a step of forming, by an etching process, a plurality of concave portions to be nozzle openings for discharging droplets and a peripheral groove, on a substrate to be processed;
a step of bonding a first support substrate to a surface of a process side of the processed substrate on which the concave portions and the peripheral groove are formed;
a step of subjecting the processed substrate to a thinning process from a surface of an opposite side of a surface bonded to the first support substrate, so that the substrate has a desired thickness thereby opening an end of each of the concave portions and the peripheral groove;
a step of bonding a second support substrate to a surface of the opened side on which the end of each of the concave portions and the peripheral groove is opened;
a step of separating the first support substrate from the processed substrate and bonding a third support substrate to the separated surface of the processed substrate; and
a step of separating the second support substrate from the processed substrate.

20. An apparatus for discharging droplets, to which the head for discharging droplets according to claim 18 is applied.
